(19) United States
(12) Patent Application Publication
(10) Pub. No.: US 2018/0045992 A1
(43) Pub. Date: Feb. 15, 2018

(54) LIQUID CRYSTAL DISPLAY PANEL AND LIQUID CRYSTAL DISPLAY DEVICE

(71) Applicant: SHENZEN CHINA STAR OPTOELECTRONICS TECHNOLOGY CO., LTD, Guangdong (CN)

(72) Inventors: Yuyeh CHEN, Guangdong (CN); Jhenwei HE, Guangdong (CN); Hao XING, Guangdong (CN)

(21) Appl. No.: 15/116,796

(22) PCT Filed: Mar. 31, 2016
(86) PCT No.: PCT/CN2016/078042

§ 371 Date: Aug. 4, 2016

(30) Foreign Application Priority Data
Jan. 25, 2016 (CN) 201610049471.0

(51) Int. Cl. G02F 1/1337

(52) U.S. Cl. CPC G02F 1/1337; G09G 2300/0452

(57) ABSTRACT

The present invention provides a liquid crystal display panel, which comprises a plurality of display blocks sequentially arranged in an array. Each of the display blocks comprises a plurality of pixel units, each of which has two display regions. The pixel units are classified into a first type of pixel units and a second type of pixel units. The pixel units of different types have different liquid crystal alignment directions or different gray-level brightness, or both of the liquid crystal alignment directions and the gray-level brightness are different for different types of pixel units. The liquid crystal display panel of the present invention has high display brightness, large viewing angle, and low manufacturing cost.

### TECHNICAL FIELD OF THE INVENTION

The present invention relates to a liquid crystal display technology, and more particularly, to a liquid crystal display panel and a liquid crystal display device.

### BACKGROUND OF THE INVENTION

As with gradual improvement of liquid crystal display technology, the resolution of a liquid crystal display panel is gradually increased as well. The resolution of the liquid crystal display panel evolves from High Definition (HD, 1280×720) and Full High Definition (FHD, 1920×1080) many years ago to Ultra High Definition (UHD, 4K×2K) now. Next generation of resolution of the liquid crystal display will reach 8K×4K or 10K×4K.

Further, in order to increase viewing angle, each pixel unit of the liquid crystal display panel is deployed with a plurality of display regions. That is, liquid crystal molecules corresponding to different regions in a same pixel unit is proceeded with different alignment orientations or directions.

As the density of the pixel units of the liquid crystal display panel is increased, the transparent area of each pixel unit is smaller and smaller. If the pixel unit is deployed with the plurality of display regions, the display brightness of each pixel unit will be dramatically lowered, thereby increasing the manufacturing cost of a corresponding liquid crystal display device.

Therefore, there is a need to provide a liquid crystal display panel and a liquid crystal display device for solving the technical problems in the existing skills.

### SUMMARY OF THE INVENTION

Accordingly, the present invention provides a liquid crystal display panel and a liquid crystal display device. By deploying different liquid crystal alignment directions and different gray-level brightness for different pixel units, the liquid crystal display panel and the liquid crystal display device increase the viewing angle, thereby assuring the display brightness of the liquid crystal display panel and lowering the manufacturing cost of the liquid crystal display panel, and thereby solving the technical problems of low brightness, small viewing angle, and high manufacturing cost in the existing liquid crystal display panels and liquid crystal display devices.

The embodiments of the present invention provide a liquid crystal display panel, comprising a plurality of display blocks sequentially arranged in an array, each of the display blocks comprising a plurality of pixel units, each of which has two display regions, the pixel units being classified into a first type of pixel units and a second type of pixel units; wherein the pixel units of different types have different liquid crystal alignment directions or different gray-level brightness, or both of the liquid crystal alignment directions and the gray-level brightness are different for different types of pixel units; wherein for the pixel units having different liquid crystal alignment directions, the liquid crystal alignment directions of the display regions are different or the ways to divide the display regions are different, or both of the liquid crystal alignment directions of the display regions and the ways to divide the display regions are different for the pixel units having different liquid crystal alignment directions; wherein the pixel units having different gray-level brightness result in different display brightness as they are driven by a same gray-level data signal; and wherein when the display block comprises two pixel units, the size of the display block corresponds to a 1*2 or 2*1 array; when the display block comprises four pixel units, the size of the display block corresponds to a 1*4, 2*2, or 4*1 array; and when the display block comprises eight pixel units, the size of the display block corresponds to a 1*8, 2*4, 4*2, or 8*1 array.

The embodiments of the present invention further provide a liquid crystal display panel, comprising a plurality of display blocks sequentially arranged in an array, each of the display blocks comprising a plurality of pixel units, each of which has two display regions, the pixel units being classified into a first type of pixel units and a second type of pixel units; wherein the pixel units of different types have different liquid crystal alignment directions or different gray-level brightness, or both of the liquid crystal alignment directions and the gray-level brightness are different for different types of pixel units.

In the liquid crystal display panel of the present invention, the display block comprises two pixel units or four pixel units.

In the liquid crystal display panel of the present invention, the pixel units are classified further into a third type of pixel units and a fourth type of pixel units.

In the liquid crystal display panel of the present invention, the display block comprises four pixel units or eight pixel units.

In the liquid crystal display panel of the present invention, the number of pixel units for the respective types of pixel units including the first type of pixel units, the second type of pixel units, the third type of pixel units, and the fourth type of pixel units is the same for each display block.

In the liquid crystal display panel of the present invention, for the pixel units having different liquid crystal alignment directions, the liquid crystal alignment directions of the display regions are different or the ways to divide the display regions are different, or both of the liquid crystal alignment directions of the display regions and the ways to divide the display regions are different for the pixel units having different liquid crystal alignment directions.

In the liquid crystal display panel of the present invention, the pixel units having different gray-level brightness result in different display brightness as they are driven by a same gray-level data signal.

In the liquid crystal display panel of the present invention, when the display block comprises two pixel units, the size of the display block corresponds to a 1*2 or 2*1 array; when the display block comprises four pixel units, the size of the display block corresponds to a 1*4, 2*2, or 4*1 array; and when the display block comprises eight pixel units, the size of the display block corresponds to a 1*8, 2*4, 4*2, or 8*1 array.

In the liquid crystal display panel of the present invention, the pixel unit is a pixel unit comprising red, green, and blue pixels, a pixel unit comprising red, green, blue, and white pixels, or a pixel unit comprising red, green, blue, and yellow pixels.

The embodiments of the present invention further provide a liquid crystal display device, comprising a liquid crystal display panel and a light source, the liquid crystal display panel comprising a plurality of display blocks sequentially arranged in an array, each of the display blocks comprising a plurality of pixel units, each of which has two display regions, the pixel units being classified into a first type of pixel units and a second type of pixel units; wherein the pixel units of different types have different liquid crystal alignment directions or different gray-level brightness, or both of the liquid crystal alignment directions and the gray-level brightness are different for different types of pixel units.

In the liquid crystal display device of the present invention, the display block comprises two pixel units or four pixel units.

In the liquid crystal display device of the present invention, the pixel units are classified further into a third type of pixel units and a fourth type of pixel units.

In the liquid crystal display device of the present invention, the display block comprises four pixel units or eight pixel units.

In the liquid crystal display device of the present invention, the number of pixel units for the respective types of pixel units including the first type of pixel units, the second type of pixel units, the third type of pixel units, and the fourth type of pixel units is the same for each display block.

In the liquid crystal display device of the present invention, for the pixel units having different liquid crystal alignment directions, the liquid crystal alignment directions of the display regions are different or the ways to divide the display regions are different, or both of the liquid crystal alignment directions of the display regions and the ways to divide the display regions are different for the pixel units having different liquid crystal alignment directions.

In the liquid crystal display device of the present invention, the pixel units having different gray-level brightness result in different display brightness as they are driven by a same gray-level data signal.

In the liquid crystal display device of the present invention, when the display block comprises two pixel units, the size of the display block corresponds to a 1*2 or 2*1 array; when the display block comprises four pixel units, the size of the display block corresponds to a 1*4, 2*2, or 4*1 array; and when the display block comprises eight pixel units, the size of the display block corresponds to a 1*8, 2*4, 4*2, or 8*1 array.

In the liquid crystal display device of the present invention, the pixel unit is a pixel unit comprising red, green, and blue pixels, a pixel unit comprising red, green, blue, and white pixels, or a pixel unit comprising red, green, blue, and yellow pixels.

By deploying different liquid crystal alignment directions and different gray-level brightness for different pixel units, the liquid crystal display panel and the liquid crystal display device of the present invention increase the viewing angle of the liquid crystal display panel, assures the display brightness of the liquid crystal display panel, lowers the manufacturing cost of the liquid crystal display panel, solves the technical problems of low brightness, small viewing angle, and high manufacturing cost in the existing liquid crystal display panels and liquid crystal display devices.

### BRIEF DESCRIPTION OF THE DRAWINGS

To make the technical schemes of the embodiments of the present invention or the existing skills more clear and specific, the following is described with a brief introduction to the drawings required in the embodiments. In the context, the drawings merely form certain embodiments in the present invention. A person having ordinary skill in the art can also come out other drawings based on these drawings without putting any creative effort into.

FIG. 1A is a structural schematic diagram showing a liquid crystal display panel in accordance with a first preferred embodiment of the present invention.

FIG. 1B is a specific structural schematic diagram showing the liquid crystal display panel in accordance with the first preferred embodiment of the present invention.

FIGS. 2A to 2C are structural schematic diagrams showing pixel units in accordance with preferred embodiments of the liquid crystal display panel of the present invention.

FIG. 3 is a structural schematic diagram showing a liquid crystal display panel in accordance with a second preferred embodiment of the present invention.

FIG. 4 is a structural schematic diagram showing a liquid crystal display panel in accordance with a third preferred embodiment of the present invention.

FIG. 5 is a structural schematic diagram showing a liquid crystal display panel in accordance with a fourth preferred embodiment of the present invention.

FIG. 6 is a structural schematic diagram showing a liquid crystal display panel in accordance with a fifth preferred embodiment of the present invention.

### DETAILED DESCRIPTION OF THE INVENTION

Please refer to the appending drawings, in which same components are indicated by a same reference number. The following descriptions are based on the specific embodiments exemplified in the present invention, which should not be used to restrict other specific embodiments not further detailed here.

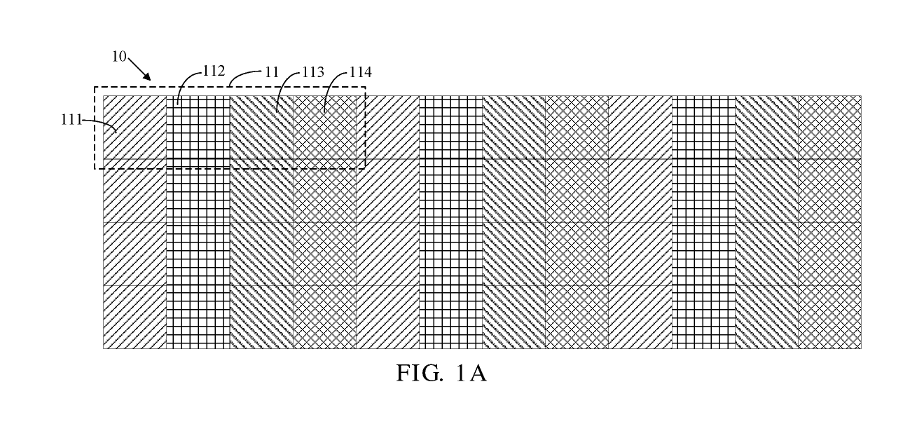

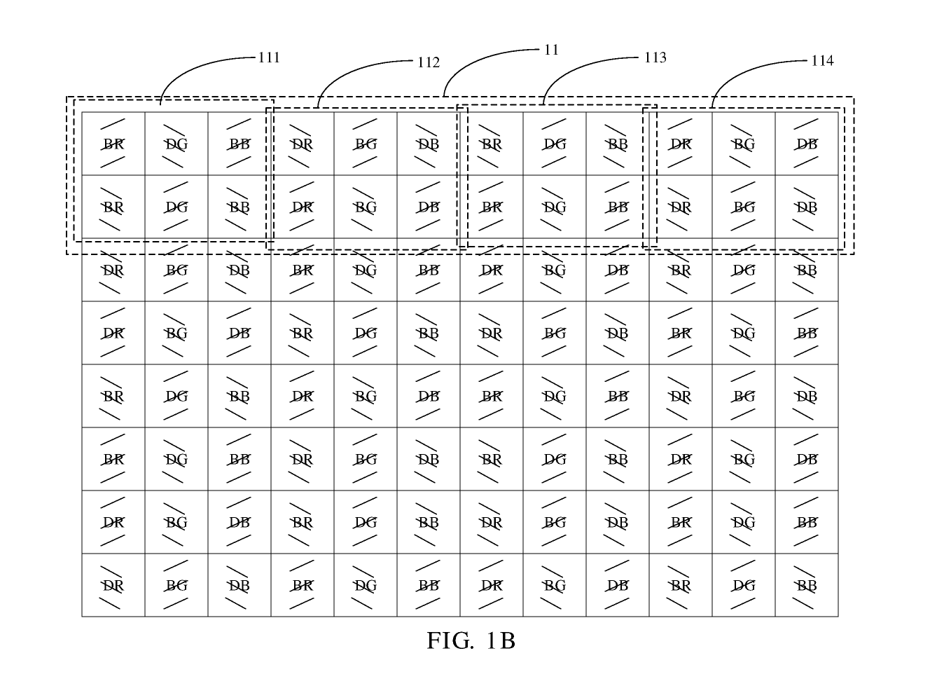

Please refer to FIG. 1A, which is a structural schematic diagram showing a liquid crystal display panel in accordance with a first preferred embodiment of the present invention. The liquid crystal display panel 10 of the present preferred embodiment comprises a plurality of display blocks 11 sequentially arranged in an array. Each of the display blocks 11 comprises a plurality of pixel units, each of which has two display regions. The pixel units being classified into a first type of pixel units 111, a second type of pixel units 112, a third type of pixel units 113, and a fourth type of pixel units 114.

The pixel units of different types have different liquid crystal alignment directions or different gray-level brightness, or both of the liquid crystal alignment directions and the gray-level brightness are different for different types of pixel units.

The liquid crystal alignment direction described here refers to the alignment direction or orientation of liquid crystal molecules in each display region of the pixel unit. If the display regions of two pixel units are divided by using different ways or in different manners, then the liquid crystal alignment directions of the two pixel units are different; if the liquid crystal alignment directions of the display regions of two pixel units are different, then the liquid crystal alignment directions of the two pixel units are different; if both of the ways to divide the display regions of two pixel units and the liquid crystal alignment directions of the display regions of two pixel units are different, then the liquid crystal alignment directions of the two pixel units are different.

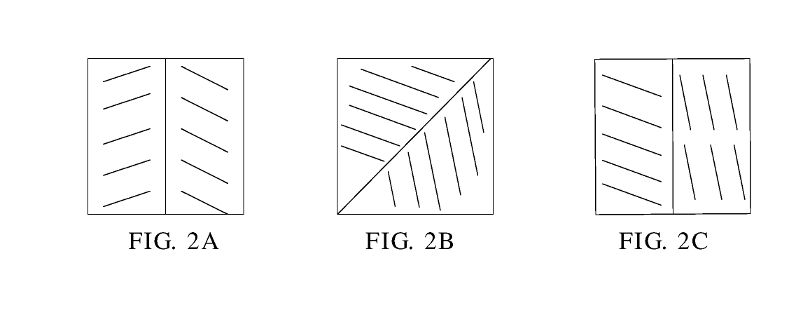

Specifically, please refer to FIGS. 2A to 2C, which are structural schematic diagrams showing pixel units in accordance with preferred embodiments of the liquid crystal display panel of the present invention. FIGS. 2A to 2C shows three types of pixel units. For the pixel units shown in FIGS. 2A and 2B, both of the ways to divide the display regions and the liquid crystal alignment directions of the display regions are different; for the pixel units shown in FIGS. 2A and 2C, the ways to divide the display regions are the same but the liquid crystal alignment directions of the display regions are different; for the pixel units shown in FIGS. 2B and 2C, the liquid crystal alignment directions of the display regions are the same but the ways to divide the display regions are different. Therefore, the liquid crystal alignment directions of the three types of pixel units depicted in FIGS. 2A to 2C are all different.

The gray-level brightness described here refers to the display brightness obtained as the pixel unit is driven by a gray-level data signal. If two pixel units result in different display brightness as they are driven by a same gray-level data signal, then the gray-level brightness of the two pixel units is different from each other.

As shown in FIG. 1A, the display block 11 of the present preferred embodiment comprises four pixel units and the number of pixel units for each type is the same. That is, the display block 11 comprises a first type of pixel units 111, a second type of pixel units 112, a third type of pixel units 113, and a fourth type of pixel units 114.

In the present preferred embodiment, the size of the display block 11 corresponds to a 1*4 array. That is, the pixel unit at the first row and the first column belongs to the first type of pixel units 111, the pixel unit at the first row and the second column belongs to the second type of pixel units 112, the pixel unit at the first row and the third column belongs to the third type of pixel units 113, the pixel unit at the first row and the fourth column belongs to the fourth type of pixel units 114, the pixel unit at the first row and the fifth column belongs to the first type of pixel units 111, . . . , the pixel unit at the (n+1)th row and the (4n+1)th column belongs to the first type of pixel units 111, the pixel unit at the (n+1)th row and the (4n+2)th column belongs to the second type of pixel units 112, the pixel unit at the (n+1)th row and the (4n+3)th column belongs to the third type of pixel units 113, and the pixel unit at the (n+1)th row and the (4n+4)th column belongs to the fourth type of pixel units 114, where n is a positive integer.

Of course, the order of the respective types of pixel units in the display block 11 is not limited. For example, the pixel units in a certain display block are arranged in an order of the first type of pixel units 111, the second type of pixel units 112, the third type of pixel units 113, and the fourth type of pixel units 114. The pixel units in the adjacent display block can be arranged in an order of the second type of pixel units 112, the first type of pixel units 111, the fourth type of pixel units 114, and the third type of pixel units 113 as long as it is assured that the number of pixel units for each type is the same in each display block 11.

The liquid crystal display panel 10 of the present preferred embodiment deploys pixel units having two different kinds of liquid crystal alignment directions and meanwhile deploys pixel units having two different kinds of gray-level brightness such that one signal display block 11 of the liquid crystal display panel 10 has 2*2=4 types of pixel units, that is, the first type of pixel units 111, the second type of pixel units 112, the third type of pixel units 113, and the fourth type of pixel units 114. Meanwhile, each pixel unit comprises two display regions having different liquid crystal alignment directions. In such a way, a single display block 11 has eight different types of display regions, and therefore it can better meet the requirements of large viewing angle in various directions in displaying the screen.

Meanwhile, it is not necessary for the pixel unit having two display regions to dispose too many driving electrodes (a region corresponding to the driving electrode is not transparent) used to separate the display regions, and therefore the display brightness of the liquid crystal display panel is much higher.

If the pixel unit of the liquid crystal display panel of the present preferred embodiment is a pixel unit comprising red, green, and blue pixels, then the detail structure of the liquid crystal display panel can be the structure depicted in FIG. 1B. Bright red (BR) pixel is a red pixel having relatively high gray-level brightness, dark red (DR) pixel is a red pixel having relatively low gray-level brightness, dark green (DG) pixel is a green pixel having relatively low gray-level brightness, bright green (BG) pixel is a green pixel having relatively high gray-level brightness, dark blue (DB) pixel is a blue pixel having relatively low gray-level brightness, and bright blue (BB) pixel is a blue pixel having relatively high gray-level brightness. The oblique slanting lines in each pixel unit are used to indicate corresponding liquid crystal alignment directions of the red, green, and blue pixels.

Since it is only required to deploy the liquid crystal molecules with two different kinds of alignment directions and the pixel units with two different gray-level brightness, both of the difficulty and the manufacturing cost are much lower, and therefore the cost of the liquid crystal display panel 10 is lower than that of a liquid crystal display panel with a pixel unit having eight display regions.

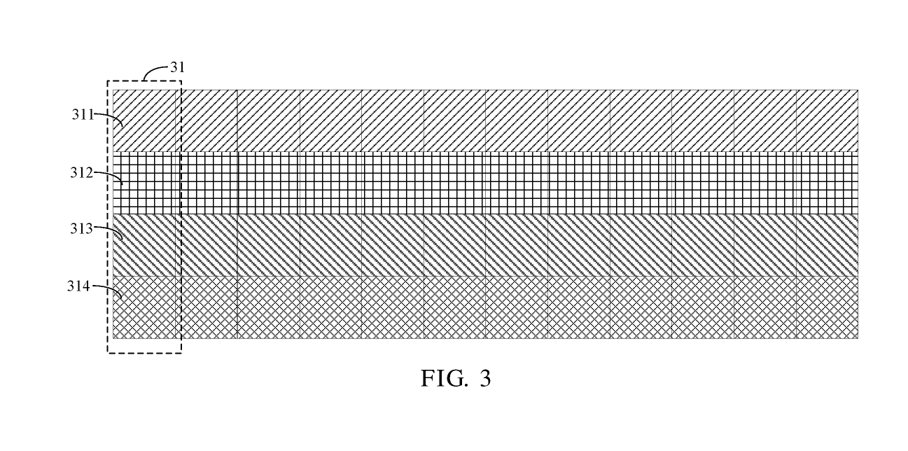

Please refer to FIG. 3, which is a structural schematic diagram showing a liquid crystal display panel in accordance with a second preferred embodiment of the present invention. The differences between the present preferred embodiment and the first preferred embodiment are that the size of the display block 31 of the present preferred embodiment corresponds to a 4*1 array. That is, the pixel unit at the first row and the first column belongs to the first type of pixel units 311, the pixel unit at the second row and the first column belongs to the second type of pixel units 312, the pixel unit at the third row and the first column belongs to the third type of pixel units 313, the pixel unit at the fourth row and the first column belongs to the fourth type of pixel units 314, the pixel unit at the fifth row and the first column belongs to the first type of pixel units 311, . . . , the pixel unit at the (4n+1)th row and the (n+1)th column belongs to the first type of pixel units 311, the pixel unit at the (4n+2)th row and the (n+1)th column belongs to the second type of pixel units 312, the pixel unit at the (4n+3)th row and the (n+1)th column belongs to the third type of pixel units 313, and the pixel unit at the (4n+4)th row and the (n+1)th column belongs to the fourth type of pixel units 314, where n is a positive integer. Similarly, the order of the respective types of pixel units in the display block 31 is not limited.

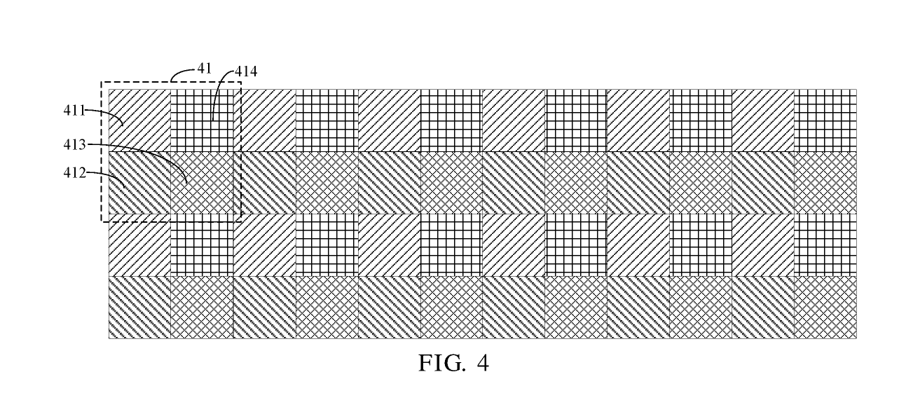

Please refer to FIG. 4, which is a structural schematic diagram showing a liquid crystal display panel in accordance with a third preferred embodiment of the present invention. The differences between the present preferred embodiment and the first preferred embodiment are that the size of the display block 41 of the present preferred embodiment corresponds to a 2*2 array. The specific arrangement thereof refer to FIG. 4, in which the reference number 411 indicates the first type of pixel unit, the reference number 412 indicates the second type of pixel unit, the reference number 413 indicates the third type of pixel unit, and the reference number 414 indicates the fourth type of pixel unit. Similarly, the order of the respective types of pixel units in the display block 41 is not limited.

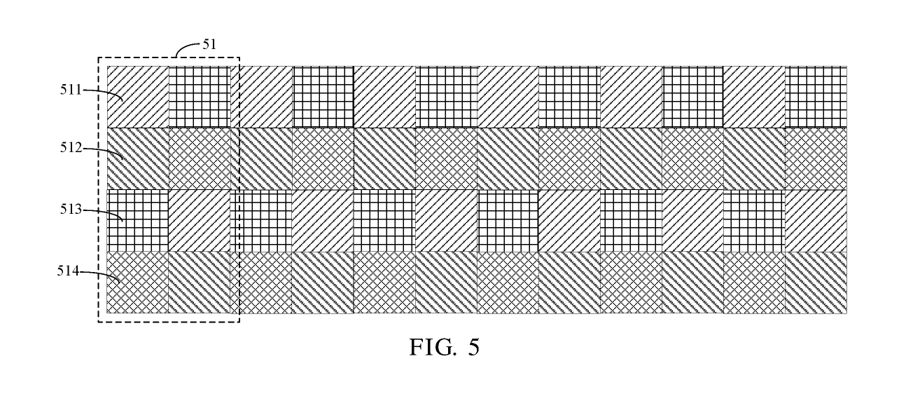

Please refer to FIG. 5, which is a structural schematic diagram showing a liquid crystal display panel in accordance with a fourth preferred embodiment of the present invention. The differences between the present preferred embodiment and the first preferred embodiment are that the display block 51 of the present preferred embodiment has eight pixel units and the size of the display block 51 corresponds to a 4*2 array. A single display block 51 comprises two pixel units of the first type 511, two pixel units of the second type 512, two pixel units of the third type 513, and two pixel units of the fourth type 514. In order to be convenient to deploy and drive the pixel units, here the respective types of pixel units in each display block are arranged according to a predetermined rule. Various orders of the respective types of pixel units in the display block are still within the scope of the present invention.

Similarly, the size of the display block having eight pixel units can also correspond to a 1*8 array, a 2*4 array, or a 8*1 array, or any other irregular size of array. Various arrays are within the scope of the present invention as long as the display blocks are arranged in an array in the liquid crystal display panel in a form of a unit. The array arrangement described here indicates that the display block having a specific shape is repeatedly arranged based on a preset condition.

Of course, here, a display block can also be deployed with sixteen pixel units or thirty-two pixel units. If there are many pixel units in the display block, the number of the pixel units of the respective types can also be different. For example, the first type of pixel units is deployed with seven pixel units, the second type of pixel units is deployed with nine pixel units, the third type of pixel units is deployed with seven pixel units, and the fourth type of pixel units is deployed with nine pixel units. Such a deployment can also achieve the above technical effects.

Preferably, the pixel unit of the liquid crystal display panel of the present preferred embodiment can be a pixel unit having red, green, and blue (RGB) pixels, a pixel unit having red, green, blue, and white (RGBW) pixels, or a pixel unit having red, green, blue, and yellow (RGBY) pixels.

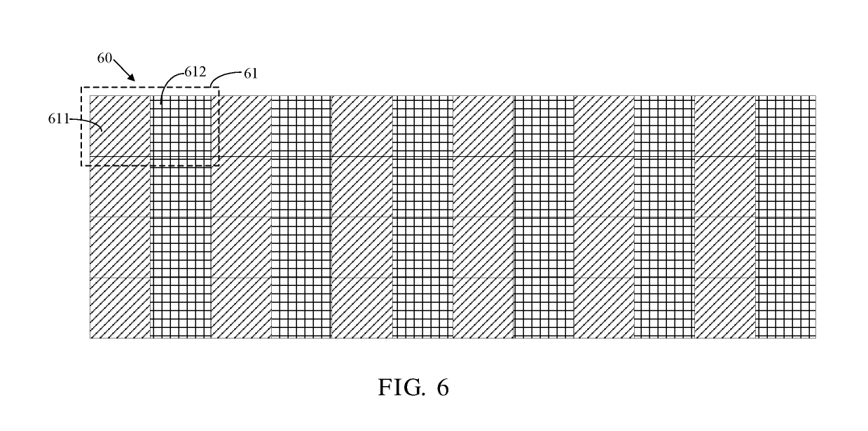

Please refer to FIG. 6, which is a structural schematic diagram showing a liquid crystal display panel in accordance with a fifth preferred embodiment of the present invention. The liquid crystal display panel 60 of the present preferred embodiment comprises a plurality of display blocks 61 sequentially arranged in an array. Each of the display blocks 61 comprises a plurality of pixel units, each of which has two display regions. The pixel units being classified into a first type of pixel units 611 and a second type of pixel units 612.

The pixel units of different types have different liquid crystal alignment directions or different gray-level brightness, or both of the liquid crystal alignment directions and the gray-level brightness are different for different types of pixel units.

The liquid crystal alignment direction described here refers to the alignment direction or orientation of liquid crystal molecules in each display region of the pixel unit.

The gray-level brightness described here refers to the display brightness obtained as the pixel unit is driven by a gray-level data signal. If two pixel units result in different display brightness as they are driven by a same gray-level data signal, then the gray-level brightness of the two pixel units is different from each other.

As shown in FIG. 6, the display block 61 of the present preferred embodiment comprises two pixel units and the number of pixel units for each type is the same. That is, the display block 61 comprises a first type of pixel units 611 and a second type of pixel units 612.

In the present preferred embodiment, the size of the display block 61 corresponds to a 1*2 array. The pixel unit at the first row and the first column belongs to the first type of pixel units 611, the pixel unit at the first row and the second column belongs to the second type of pixel units 612, the pixel unit at the first row and the third column belongs to the first type of pixel units 611, . . . , the pixel unit at the (n+1)th row and the (2n+1)th column belongs to the first type of pixel units 611, and the pixel unit at the (n+1)th row and the (2n+2)th column belongs to the second type of pixel units 612, where n is a positive integer. Of course, here, the size of the display block 61 can also correspond to a 2*1 array.

Of course, the order of the respective types of pixel units in the display block 61 is not limited.

The liquid crystal display panel 60 of the present preferred embodiment deploys pixel units having two different kinds of liquid crystal alignment directions or two different kinds of gray-level brightness such that one signal display block 61 of the liquid crystal display panel 60 has two types of pixel units, that is, the first type of pixel units 611 and the second type of pixel units 612. Meanwhile, each pixel unit comprises two display regions having different liquid crystal alignment directions. In such a way, a single display block 61 has four different types of display regions, and therefore it can better meet the requirements of large viewing angle in various directions in displaying the screen.

Meanwhile, it is not necessary for the pixel unit having two display regions to dispose too many driving electrodes (a region corresponding to the driving electrode is not transparent) used to separate the display regions, and therefore the display brightness of the liquid crystal display panel is much higher.

Since it is only required to deploy the liquid crystal molecules with two different kinds of alignment directions and the pixel units with two different gray-level brightness, both of the difficulty and the manufacturing cost are much lower, and therefore the cost of the liquid crystal display panel 61 is lower than that of a liquid crystal display panel with a pixel unit having eight display regions.

By deploying different liquid crystal alignment directions and different gray-level brightness for different pixel units, the liquid crystal display panel of the present preferred embodiment increases the viewing angle of the liquid crystal display panel, assures the display brightness of the liquid crystal display panel, and lowers the manufacturing cost of the liquid crystal display panel.

The present invention further provides a liquid crystal display device. The liquid crystal display device comprises a liquid crystal display panel and a light source. The liquid crystal display panel comprises a plurality of display blocks sequentially arranged in an array. Each of the display blocks comprising a plurality of pixel units, each of which has two display regions. The pixel units are classified into a first type of pixel units and a second type of pixel units.

The pixel units of different types have different liquid crystal alignment directions or different gray-level brightness, or both of the liquid crystal alignment directions and the gray-level brightness are different for different types of pixel units.

Preferably, the pixel units are classified further into a third type of pixel units and a fourth type of pixel units.

Preferably, the display block comprises two pixel units, four pixel units, or eight pixel units.

Preferably, the number of pixel units for the respective types of pixel units including the first type of pixel units, the second type of pixel units, the third type of pixel units, and the fourth type of pixel units is the same for each display block.

Preferably, for the pixel units having different liquid crystal alignment directions, the liquid crystal alignment directions of the display regions are different or the ways to divide the display regions are different, or both of the liquid crystal alignment directions of the display regions and the ways to divide the display regions are different for the pixel units having different liquid crystal alignment directions.

Preferably, the pixel units having different gray-level brightness result in different display brightness as they are driven by a same gray-level data signal.

Preferably, when the display block comprises two pixel units, the size of the display block corresponds to a 1*2 or 2*1 array;

Preferably, when the display block comprises four pixel units, the size of the display block corresponds to a 1*4, 2*2, or 4*1 array; and

Preferably, when the display block comprises eight pixel units, the size of the display block corresponds to a 1*8, 2*4, 4*2, or 8*1 array.

Preferably, the pixel unit is a pixel unit comprising red, green, and blue pixels, a pixel unit comprising red, green, blue, and white pixels, or a pixel unit comprising red, green, blue, and yellow pixels.

By deploying different liquid crystal alignment directions and different gray-level brightness for different pixel units, the liquid crystal display panel and the liquid crystal display device of the present preferred embodiment increase the viewing angle of the liquid crystal display panel, assures the display brightness of the liquid crystal display panel, lowers the manufacturing cost of the liquid crystal display panel, solves the technical problems of low brightness, small viewing angle, and high manufacturing cost in the existing liquid crystal display panels and liquid crystal display devices.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A liquid crystal display panel, comprising a plurality of display blocks sequentially arranged in an array, each of the display blocks comprising a plurality of pixel units, each of which has two display regions, the pixel units being classified into a first type of pixel units and a second type of pixel units;
wherein the pixel units of different types have different liquid crystal alignment directions or different gray-level brightness, or both of the liquid crystal alignment directions and the gray-level brightness are different for different types of pixel units;
wherein for the pixel units having different liquid crystal alignment directions, the liquid crystal alignment directions of the display regions are different or the ways to divide the display regions are different, or both of the liquid crystal alignment directions of the display regions and the ways to divide the display regions are different for the pixel units having different liquid crystal alignment directions;
wherein the pixel units having different gray-level brightness result in different display brightness as they are driven by a same gray-level data signal; and
wherein when the display block comprises two pixel units, the size of the display block corresponds to a 1*2 or 2*1 array;
when the display block comprises four pixel units, the size of the display block corresponds to a 1*4, 2*2, or 4*1 array; and
when the display block comprises eight pixel units, the size of the display block corresponds to a 1*8, 2*4, 4*2, or 8*1 array.

2. A liquid crystal display panel, comprising a plurality of display blocks sequentially arranged in an array, each of the display blocks comprising a plurality of pixel units, each of which has two display regions, the pixel units being classified into a first type of pixel units and a second type of pixel units;
wherein the pixel units of different types have different liquid crystal alignment directions or different gray-level brightness, or both of the liquid crystal alignment directions and the gray-level brightness are different for different types of pixel units.

3. The liquid crystal display panel according to claim 2, wherein the display block comprises two pixel units or four pixel units.

4. The liquid crystal display panel according to claim 2, wherein the pixel units are classified further into a third type of pixel units and a fourth type of pixel units.

5. The liquid crystal display panel according to claim 4, wherein the display block comprises four pixel units or eight pixel units.

6. The liquid crystal display panel according to claim 5, wherein the number of pixel units for the respective types of pixel units including the first type of pixel units, the second type of pixel units, the third type of pixel units, and the fourth type of pixel units is the same for each display block.

7. The liquid crystal display panel according to claim 2, wherein for the pixel units having different liquid crystal alignment directions, the liquid crystal alignment directions of the display regions are different or the ways to divide the display regions are different, or both of the liquid crystal alignment directions of the display regions and the ways to divide the display regions are different for the pixel units having different liquid crystal alignment directions.

8. The liquid crystal display panel according to claim 2, wherein the pixel units having different gray-level brightness result in different display brightness as they are driven by a same gray-level data signal.

9. The liquid crystal display panel according to claim 2, wherein when the display block comprises two pixel units, the size of the display block corresponds to a 1*2 or 2*1 array;
when the display block comprises four pixel units, the size of the display block corresponds to a 1*4, 2*2, or 4*1 array; and
when the display block comprises eight pixel units, the size of the display block corresponds to a 1*8, 2*4, 4*2, or 8*1 array.

10. The liquid crystal display panel according to claim 2, wherein the pixel unit is a pixel unit comprising red, green, and blue pixels, a pixel unit comprising red, green, blue, and white pixels, or a pixel unit comprising red, green, blue, and yellow pixels.

11. A liquid crystal display device, comprising a liquid crystal display panel and a light source, the liquid crystal display panel comprising a plurality of display blocks sequentially arranged in an array, each of the display blocks comprising a plurality of pixel units, each of which has two display regions, the pixel units being classified into a first type of pixel units and a second type of pixel units;
wherein the pixel units of different types have different liquid crystal alignment directions or different gray-level brightness, or both of the liquid crystal alignment directions and the gray-level brightness are different for different types of pixel units.

12. The liquid crystal display device according to claim 11, wherein the display block comprises two pixel units or four pixel units.

13. The liquid crystal display device according to claim 11, wherein the pixel units are classified further into a third type of pixel units and a fourth type of pixel units.

14. The liquid crystal display device according to claim 13, wherein the display block comprises four pixel units or eight pixel units.

15. The liquid crystal display device according to claim 14, wherein the number of pixel units for the respective types of pixel units including the first type of pixel units, the second type of pixel units, the third type of pixel units, and the fourth type of pixel units is the same for each display block.

16. The liquid crystal display device according to claim 11, wherein for the pixel units having different liquid crystal alignment directions, the liquid crystal alignment directions of the display regions are different or the ways to divide the display regions are different, or both of the liquid crystal alignment directions of the display regions and the ways to divide the display regions are different for the pixel units having different liquid crystal alignment directions.

17. The liquid crystal display device according to claim 11, wherein the pixel units having different gray-level brightness result in different display brightness as they are driven by a same gray-level data signal.

18. The liquid crystal display device according to claim 11, wherein when the display block comprises two pixel units, the size of the display block corresponds to a 1*2 or 2*1 array;
when the display block comprises four pixel units, the size of the display block corresponds to a 1*4, 2*2, or 4*1 array; and
when the display block comprises eight pixel units, the size of the display block corresponds to a 1*8, 2*4, 4*2, or 8*1 array.

19. The liquid crystal display device according to claim 11, wherein the pixel unit is a pixel unit comprising red, green, and blue pixels, a pixel unit comprising red, green, blue, and white pixels, or a pixel unit comprising red, green, blue, and yellow pixels.
